(19) United States
(12) Patent Application Publication
(10) Pub. No.: US 2012/0026673 A1
(43) Pub. Date: Feb. 2, 2012

(54) MOUNTING APPARATUS FOR DATA STORAGE DEVICE

(75) Inventor: ZHENG-HENG SUN, Tu-Cheng (TW)

(73) Assignee: HON HAI PRECISION INDUSTRY CO., LTD., Tu-Cheng (TW)

(21) Appl. No.: 12/871,844

(22) Filed: Aug. 30, 2010

(30) Foreign Application Priority Data
Jul. 29, 2010 (CN) 201010240048.1

(51) Int. Cl. G06F 1/16; F16M 13/02

(52) U.S. Cl. 361/679.33; 248/224.8

(57) ABSTRACT

A mounting apparatus for mounting a data storage device to a chassis includes a support bracket fixed to the chassis, a number of positioning members attached to the data storage device and supported on the support bracket, and a latch mechanism. The support bracket includes a main body defining a locking hole. The latch mechanism includes a latch member engaging with the data storage device. The latch member includes a resilient locking tab engaging in the locking hole of the main body of the support bracket. The locking tab deflects to disengage from the locking hole of the main body of the support bracket.

### BACKGROUND

1. Technical Field

The present disclosure relates to a mounting apparatus for a data storage device.

2. Description of Related Art

An electronic device, such as a computer, is generally equipped with a data storage device, such as a hard disk drive. Mounting the storage device to the electronic device by traditional screw type fasteners is inefficient and always requires tools, such as a screw driver.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is an exploded, isometric view of an exemplary embodiment of a mounting apparatus, a data storage device, and a chassis, the mounting apparatus includes a support bracket, a latch mechanism, and four positioning members.

FIG. 2 is an enlarged view of the support bracket of FIG. 1, but shown from a different perspective.

FIG. 3 is an assembled, isometric view of the latch mechanism of FIG. 1, but shown from a different perspective.

FIG. 4 is an enlarged view of one of the positioning members of FIG. 1.

FIG. 5 is an assembled view of FIG. 1.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references mean at least one.

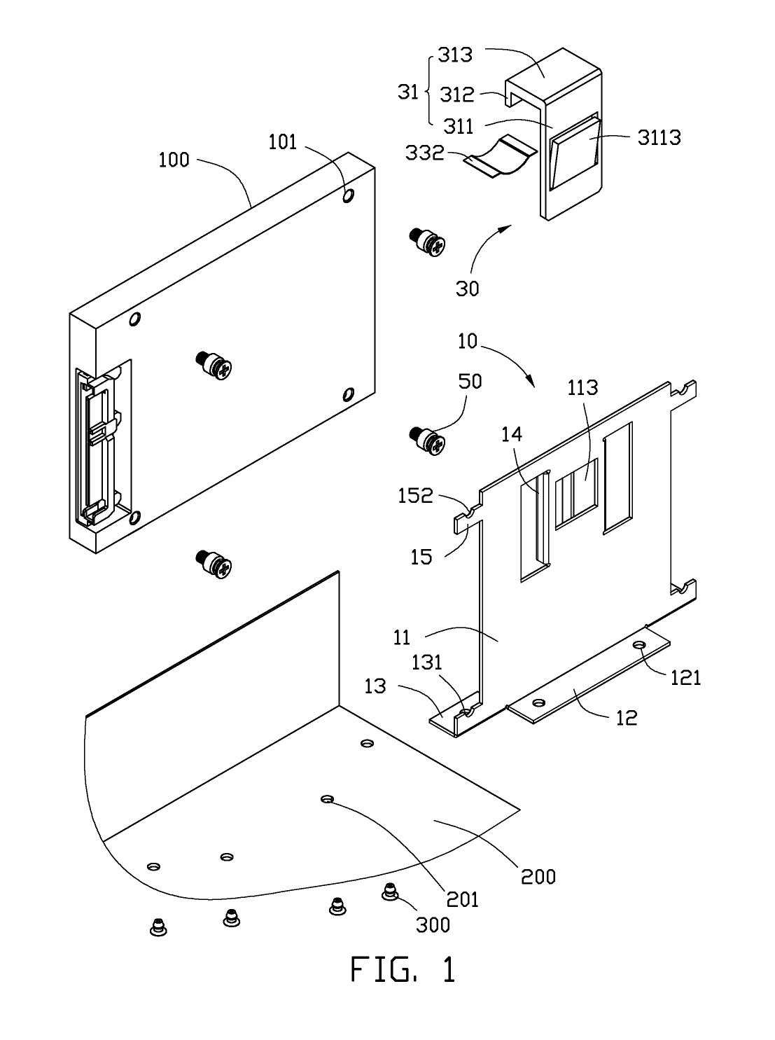

Referring to FIG. 1, an exemplary embodiment of a mounting apparatus is provided for mounting a data storage device 100, such as a hard disk drive, to a chassis 200 of a computer. A mounting hole 101 is defined in a side of the data storage device 100, adjacent to each of four corners of the data storage device 100. A plurality of securing holes 201 is defined in a bottom plate of the chassis 200. The mounting apparatus includes a support bracket 10, a latch mechanism 30, and four positioning members 50.

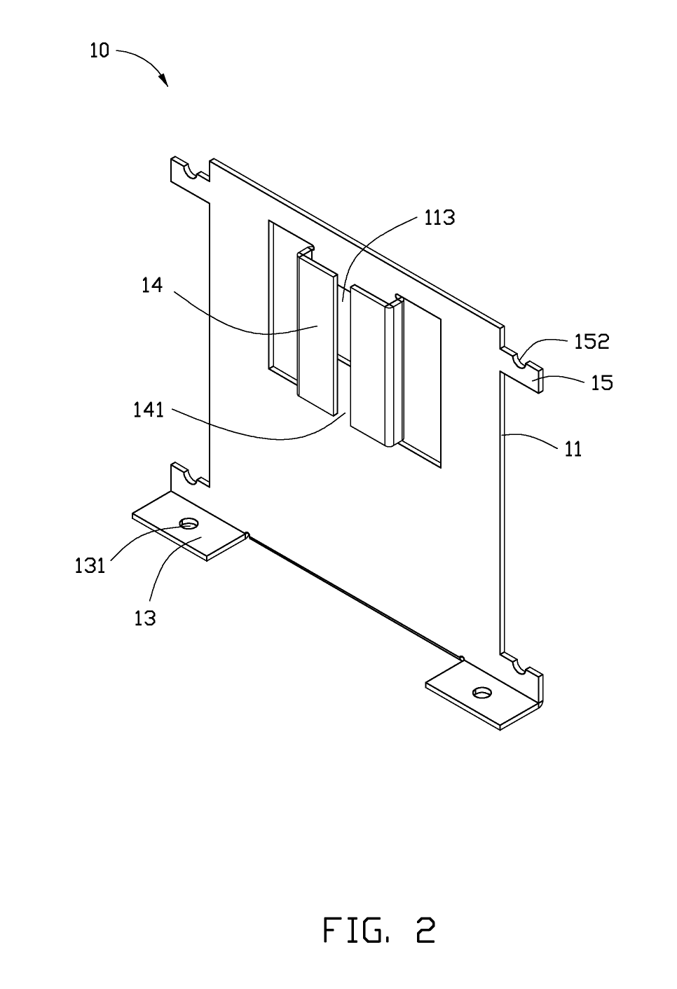

Referring to FIGS. 1 and 2, the support bracket 10 includes a rectangular main body 11, a first flange 12 perpendicularly extending from a bottom of the main body 11, and two second flanges 13 perpendicularly extending from the first side of the main body 11 and opposite to the first flange 12. The first flange 12 is located between the second flanges 13. Two L-shaped guiding portions 14 extend from a middle of the main body 11, adjacent to a top of the main body 11. Four support tabs 15 extending from left and right sides of the main body 11. The main body 11 defines a locking hole 113 therein between the guiding portions 14. The first flange 12 defines two retaining holes 121. Each of the second flanges 13 defines a retaining hole 131. The guiding portions 14 extend towards each other to cooperatively form a guiding slot 141 together with the main body 11. A semicircular cutout 152 is defined in a top side of each of the support tabs 15.

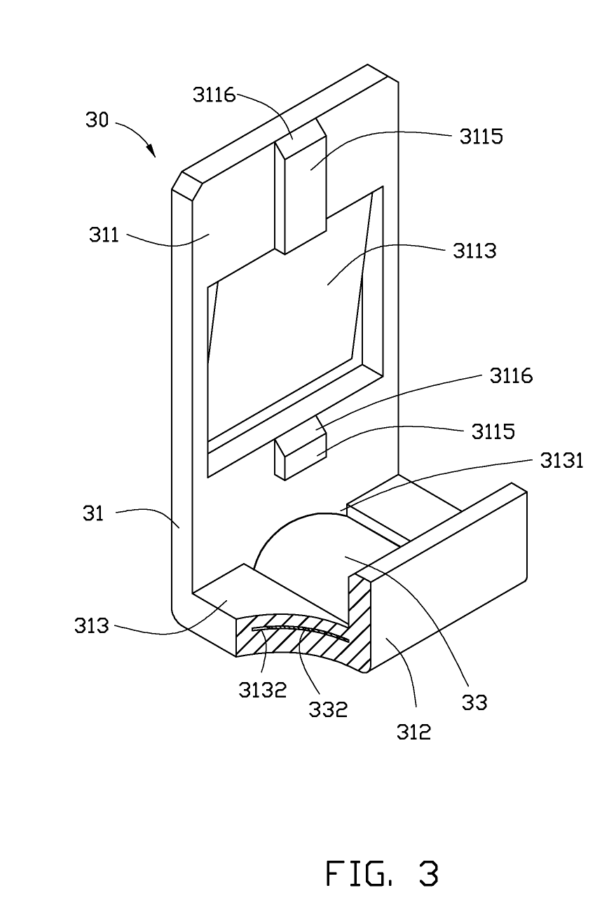

Referring to FIGS. 1 and 3, the latch mechanism 30 includes a latch member 31 and a resilient member 33. The latch member 31 includes a pressing portion 313, and a first holding portion 311 and a second holding portion 312 perpendicularly extending along the same direction from opposite sides of the press portion 313. The first holding portion 311 is taller than the second holding portion 312. A resilient locking tab 3113 extends from a middle of the first holding portion 311 and slantingly extends out from the second holding portion 313 in an unforced state. Two alignment blocks 3115 protrude from a side of the first holding portion 311 facing the second holding portion 312. A recessed area 3131 is defined in a side of the pressing portion 313 facing the first and second holding portions 311, 312. Two snapping slots 3132 are defined in the pressing portion 313 at opposite sides of the recessed area 3131, and communicate with the recessed area 3131. In one embodiment, the resilient member 33 is an arc-shaped spring piece accommodated in the recessed area 3131, and includes two inserting portions 332 formed at opposite sides.

In assembly of the latch mechanism 30, the inserting portions 332 of the resilient member 30 are correspondingly engaged in the snapping slots 3132 of the pressing portion 313 of the latch member 31, to attach the resilient member 33 to the latch member 31. The resilient member 33 aligns with the recessed area 3131 of the pressing portion 313, and protrudes away from the pressing portion 313.

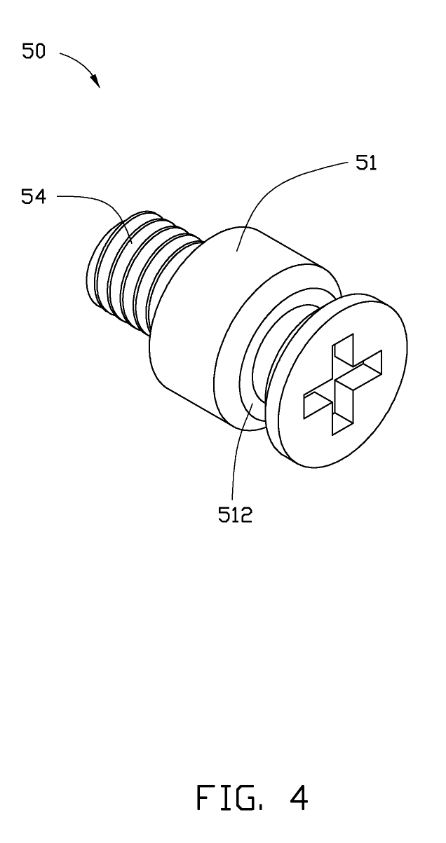

Referring to FIG. 4, each of the positioning members 50 is substantially columnar, and includes a post body 51, and a threaded coupling portion 54 extending from an end of the post body 51. The post body 51 defines an annular groove 512 in a circumference of the post body 51.

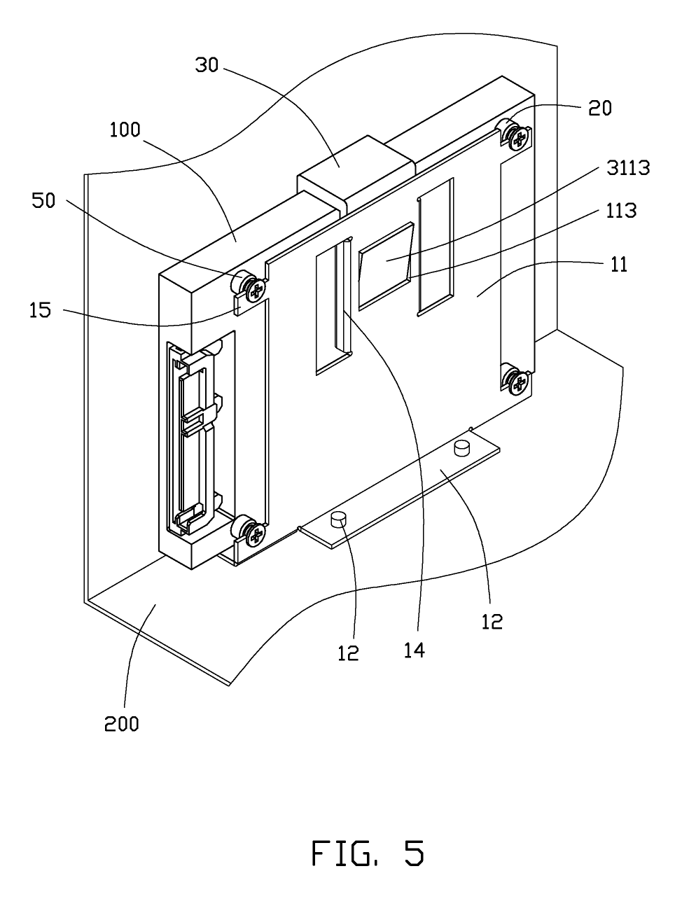

Referring to FIG. 5, to mount the data storage device 100 to the chassis 200, the support bracket 10 is placed on the chassis 200 with the retaining holes 121, 131 of the first and second flanges 12, 13 of the support bracket 10 aligning with the corresponding securing holes 201 of the chassis 200. A plurality of fasteners, such as rivets 300, are correspondingly secured in the securing holes 201 of the chassis 200 and the retaining holes 121, 131 of the support bracket 10 to secure the support bracket 10 to the chassis 200 with the main body 11 of the support bracket 10 perpendicularly extending up from the bottom plate of the chassis 200. The positioning members 50 are attached to the side of the data storage device 100, with the coupling portions 54 of the positioning members 50 engaging in the corresponding mounting holes 101 of the data storage device 100. The positioning members 50 are supported on the corresponding support tabs 15, with the positioning members 50 received in the cutouts 152 of the corresponding support tabs 15, meanwhile, the support tabs 15 engaged in the grooves 512 of the corresponding positioning members 50. Therefore, the data storage device 100 is attached to the support bracket 10, with the side of the data storage device 100 substantially parallel with the main body 11 of the support bracket 10. The latch member 31 is lifted over the data storage device 100 to align the alignment blocks 3115 of the latch member 31 with the guiding slot 141 of the support bracket 10. With the alignment blocks 3115 of the latch member 31 sliding downwards along the guiding slot 141 of the support bracket 10, the first holding portion 311 is inserted between the data storage device 100 and the main body 11 of the support bracket 10 until the locking tab 3113 engages in the locking hole 113 of the main body 11 of the support bracket 10. At the same time, the data storage device 100 is sandwiched between the first and second holding portions 311, 312. The top of the storage device 100 resists against the resilient member 33 to compress the resilient member 33.

To detach the data storage device 100, the locking tab 3113 is depressed to disengage from the locking hole 113 of the support bracket 10. The resilient member 33 restores driving the locking member 31 up from the data storage device 100. The latch mechanism 30 may then be taken off from the data storage device 100. The data storage device 100 may then be disengaged from the support bracket 10 and be detached from the chassis 200.

It is to be understood, however, that even though numerous characteristics and advantages of the embodiments have been set forth in the foregoing description, together with details of the structure and function of the embodiments, the present disclosure is illustrative only, and changes may be made in details, especially in matters of shape, size, and arrangement of parts within the principles of the embodiments to the full extent indicated by the broad general meaning of the terms in which the appended claims are expressed.

What is claimed is:

1. A mounting apparatus for mounting a data storage device to a chassis, the mounting apparatus comprising:
a support bracket fixed to the chassis, and defining a locking hole;
a plurality of positioning members attached to the data storage device and supported on the support bracket;
a latch mechanism comprising a locking tab extending into the locking hole of the support bracket and deformable to disengage from the locking hole of the supporting member.

2. The mounting apparatus of claim 1, wherein the support bracket comprises a plate-shaped main body, the locking hole is defined in the main body, the positioning members extend form a side of the data storage device.

3. The mounting apparatus of claim 1, wherein the support bracket comprises a plurality of support tabs extending from the main body to correspondingly support the positioning members.

4. The mounting apparatus of claim 3, wherein each of the support tabs defines a cutout to receive a corresponding one of the positioning members.

5. The mounting apparatus of claim 4, wherein each of the positioning members defines a groove engaging with the corresponding support tab.

6. The mounting apparatus of claim 1, wherein the latch mechanism comprises a latch member comprising a first holding portion, and a second hold portion parallel to the first holding portion, to sandwich the data storage device between the first and the second holding portions.

7. The mounting apparatus of claim 6, wherein the first holding portion is positioned between the data storage device and the main body of the support bracket, the locking tab extends from the first holding portion away from the second holding portion.

8. The mounting apparatus of claim 7, wherein the support bracket comprises two guiding portions extending from a side of the main body of the support bracket facing the data storage device, and cooperatively bounding a guiding slot together with the main body, an alignment block protrudes from the first holding portion of the latch member, to slidably received in the guiding slot.

9. The mounting apparatus of claim 8, wherein each of the guiding portions of the support bracket is L-shaped, and the two guiding portions are corresponding located at opposite sides of the locking hole of the support bracket.

10. The mounting apparatus of claim 6, wherein the latch member comprises a pressing portion connected to corresponding ends of the first and second holding portions of the latch member, and a resilient member mounted to the pressing portion of the latch member and resisting against the data storage member in response to the latch member retaining the data storage device to the support bracket.

11. A data storage device assembly installed in a chassis, the storage device assembly comprising:
a storage device;
a plurality of positioning members extending from a side of the storage device;
a support bracket fixed to the chassis, supporting the positioning members, and defining a locking hole;
a latch member coupled to the storage device, and comprising a resilient tab extending into the locking hole of the support bracket and deformable to disengage from the locking hole of the supporting member.

12. The data storage device assembly of claim 11, wherein the support bracket comprises a plate-shaped main body perpendicularly extending up from a bottom of the chassis, the side of positioning members abuts and is parallel to the main body.

13. The data storage device assembly of claim 12, wherein the locking hole is defined in the main body, the latch member comprises a first holding portion extending into between the data storage device and the main body of the support bracket, the locking tab extends from the first holding portion.

14. The data storage device assembly of claim 13, wherein the latch member further comprises a second hold portion parallel to the first holding portion, the data storage is sandwiched between the first and the second holding portions of the latch member.

15. The data storage device assembly of claim 14, further comprising a resilient member, wherein the latch member further comprises a pressing portion connected to corresponding ends of the first and second holding portions of the latch member, the resilient member is mounted to the pressing portion of the latch member and resists against the data storage member in response to the latch member retaining the data storage device to the support bracket.
